(19) United States
(12) Patent Application Publication
(10) Pub. No.: US 2005/0223949 A1
(43) Pub. Date: Oct. 13, 2005

(54) Starch binder compositions, methods of making the same and products formed therefrom

(76) Inventors: Kenneth E. Bailey JR., Dodge City, KS (US); Alice M. Rogers, Spearville, KS (US); Gerald R. Shetron, Dodge City, KS (US); Larry J. Ingram, Lenexa, KS (US)

Correspondence Address: KIRKPATRICK & LOCKHART NICHOLSON GRAHAM LLP;HENRY W. OLIVER BUILDING, 535 SMITHFIELD STREET, PITTSBURGH, PA, 15222, US

(21) Appl. No.: 10/820,972

(22) Filed: Apr. 8, 2004

(51) Int. Cl. B32B 29/02; C04B 16/08

(52) U.S. Cl. 106/783; 428/292.7

(57) ABSTRACT

A starch binder composition, methods of forming the same, and products formed therefrom, wherein the starch composition comprises a viscosity profile wherein at a 14.5% solids concentration, a starting temperature of 30° C., and a heating/cooling rate of 7.5° C./min, the composition at a time 0 through gelatinization undergoes a viscosity increase to a maximum value in the range of 600 and 1600 BU torque at a time in the range of 6.5 to 7.2 minutes, followed by a decrease in viscosity and a subsequent increase in viscosity at the end of a final holding period to a value that is substantially the same as the maximum value, based on a Brabender micro visco amylograph.

### FIELD OF THE INVENTION

The present invention is directed to starch binder compositions, methods of forming the same, and products formed therefrom.

### BACKGROUND

Gypsum board is a popular and conventional building material that is used in various types of building products such as, for example, walls, floors, and ceiling boards. Gypsum wallboard comprises a core material positioned between two porous sheet members, such as paperboard. The core material is typically formed from a plaster slurry that includes the combination of calcined gypsum, a reinforcing agent, a surfactant agent, a binder material, and water. The slurry is deposited and pressed between two continuous sheets of paper that are then allowed to take a “set” as the continuous sheet is conveyed to a cutter station where the board is cut into the desired lengths. The cut sheets may then be conveyed through drying kilns to remove excess moisture from the board and to enhance the migration of the soluble sugars (dextrins) in the acid modified starch to the paper/core interface to form a chemical bond.

Acid modified industrial grain sorghum, a thin boiling starch, is a known core binder material that is added to the plaster slurry in the manufacture of gypsum wallboard. When added to the slurry and pressed between the paperboard sheets, the soluble sugars of the modified sorghum migrate toward and partially into the sheets during the set and drying stage of manufacture, thereby promoting a chemical bond between the paper and core interface.

Various attempts have been made to improve the properties of the gypsum wallboard or the components that form the board by altering or adjusting the chemistries of these components or by adjusting the process conditions employed. In many instances, efforts to improve the physical properties of the gypsum wallboard or the components that form the board have significantly increased the manufacturing cost of the finished board, while efforts to reduce the manufacturing cost of the finished board have, at times, adversely impacted the physical properties of the board. For example, previous attempts to reduce the weight of the gypsum wallboard have included reducing the board density through the creation of air pockets with the addition of foam or soap slurries to the slurry of gypsum plaster. Although successful in reducing material usage and board weight, these efforts have adversely impacted the strength of the board, as measured by the force required for the board to be pulled over the head of a nail, known as “nail pull”. In addition, attempts have been made to increase the dry bond adhesion of the core material to the paperboard through the addition of a conventional binder material and an additive, such as zirconium salt, to the plaster slurry. These attempts generally increase the overall cost of the gypsum wallboard by introducing additional and relatively expensive raw materials into the plaster slurry.

Although substantial efforts have been made to develop various slurry formulations and/or manufacturing processes that produce cost effective gypsum wallboard having improved physical properties, a continued need exists to provide improved gypsum slurries, by the introduction of components into the slurry or their methods of manufacture, that have reduced manufacturing cost and/or provide one or more improved physical properties to the resultant gypsum board product.

### SUMMARY

In one embodiment, the present invention provides an acid modified dry-milled starch composition comprising a viscosity profile wherein at a 14.5% solids concentration, a starting temperature of 30° C., and a heating rate increase of 7.5° C./min, the composition at a time 0 through gelatinization undergoes a viscosity increase to a maximum value in the range of 600 and 1600 BU torque at a time in the range of 6.5 to 7.2 minutes, followed by a decrease in viscosity to a value in the range of 240 to 640 torque at a time of 8.4 minutes, based on a Brabender micro visco amylograph.

In another embodiment, the present invention provides an acid modified dry-milled starch composition comprising a viscosity profile wherein at a 14.5% solids concentration, a starting temperature of 30° C., and a heating rate increase of 7.5° C./min, the composition at a time 0 through gelatinization undergoes a viscosity increase to a maximum value in the range of 600 and 1600 BU torque at a time in the range of 6.5 to 7.2 minutes, followed by at least a 40 percent decrease in viscosity at a time of 8.4 minutes, based on a Brabender micro visco-amylo-graph.

The present invention also provides an acid modified dry-milled starch composition comprising a viscosity profile wherein at a 14.5% solids concentration, a starting temperature of 30° C., and a heating/cooling rate of 7.5° C./min, the composition at a time 0 through gelatinization undergoes a viscosity increase to a maximum value in the range of 600 and 1600 at a time in the range of 6.5 to 7.2 minutes, followed by a decrease in viscosity and a subsequent increase in viscosity at the end of a final holding period to a value that is substantially the same as the maximum value, based on a Brabender micro visco amylograph.

In another embodiment, the present invention provides an acid modified dry-milled starch composition formed by a process comprising combining an acid component and a starch component to form a mixture, wherein the ratio of the acid component is added, at least in part, relative to the fat percent in the starch component.

The present invention also provides a method of forming an acid modified starch composition. The process comprises combining an acid component and a starch component to form a mixture, wherein the ratio of the acid component is added, at least in part, relative to the fat percent in the starch component, and heating the mixture to a temperature of 85° C. or less for a sufficient time effective to obtain the acid modified starch.

It should be understood that this invention is not limited to the embodiments disclosed in this Summary, and it is intended to cover modifications that are within the spirit and scope of the invention, as defined by the claims.

### BRIEF DESCRIPTION OF THE DRAWINGS

FIG. 1 is a diagram illustrating one embodiment of the process of the present invention;

FIG. 2 is a graphic illustration of the relationship between the percent fat content and the amount of acid employed per pound of starch;

FIG. 3 is a Brabender micro visco amylograph of a slurry containing 33.3% solids of a conventional binder composition;

FIG. 4 is a Brabender micro visco amylograph of a slurry containing 33.3% solids of a conventional binder composition;

FIG. 5 is a Brabender micro visco amylograph of a slurry containing 14.5% solids of one embodiment of the binder composition of the present invention; and

FIG. 6 is a Brabender micro visco amylograph of a slurry containing 14.5% solids of one embodiment of the binder composition of the present invention.

### DETAILED DESCRIPTION OF THE INVENTION

Other than in the operating examples, or unless otherwise expressly specified, all of the numerical ranges, amounts, values and percentages such as those for amounts of materials, times and temperatures of reaction, ratios of amounts, and others in the following portion of the specification may be read as if prefaced by the word “about” even though the term “about” may not expressly appear with the value, amount or range. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements. Furthermore, when numerical ranges of varying scope are set forth herein, it is contemplated that any combination of these values inclusive of the recited values may be used.

Any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material said to be incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

As used herein the term “dry-milled starch” refers to the flour product of a processed raw grain in the substantial absence of liquid, as compared to the pure starch of a wet milled cereal grain. Dry milled starches will be understood to include the whole cereal grains themselves, grains with much or all of the seedcoats removed, or individual tissues such as endosperms, in various particle sizes depending upon the types of separations performed during the milling processes and the extent of processing of the tissues by grinding or crushing. Various terms may be employed to describe or identify these materials, such as whole grain, grits, meal, flakes, or flour.

As used herein, the term “gelatinization” refers to the irreversible physico-chemical change of a starch composition wherein the starch granules swell upon the addition of a solvent and heat. Gelatinization onset is illustrated at the point when the viscosity of the starch slurry composition initially increases upon the addition of heat.

As used herein, the term “acid modified starch” refers to a class of starches that have properties that have been chemically and/or physically altered through the addition of an acid to perform degradative attacks on the starch molecule. The principle objective of acid modification is to decrease the molecular weight of the starch by breaking the starch chains and to reduce the hot paste viscosity; thus the term “thin-boiling” starch.

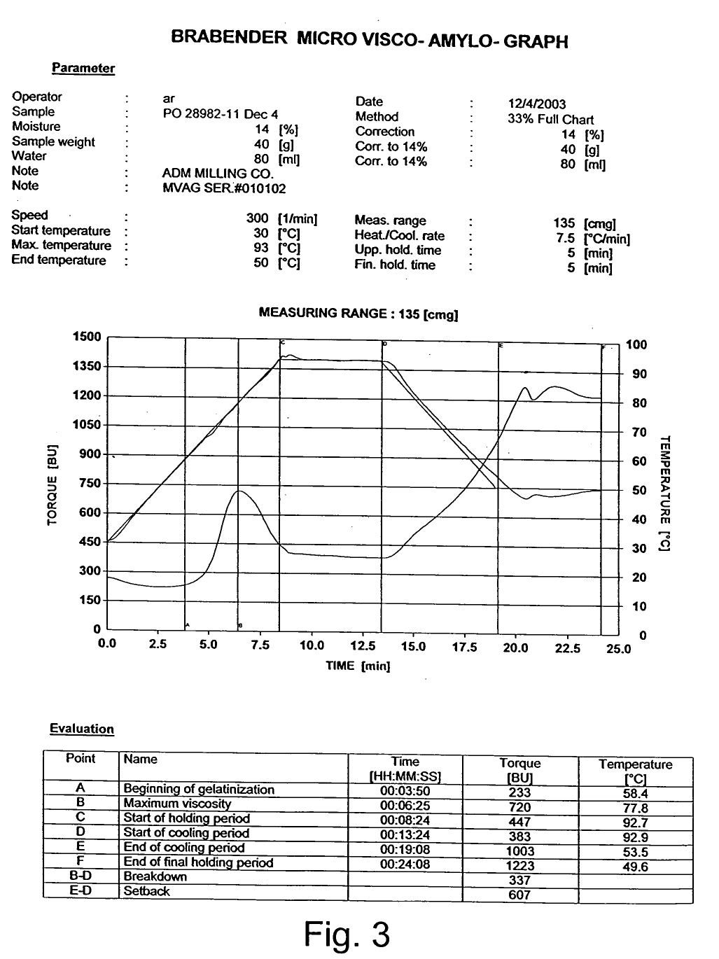

As used herein a “Brabender micro visco amylograph” is a measuring devise to determine the viscosity profile of a starch slurry at a given percent solids by measuring viscosity relative to time at a given start temperature, temperature rate increase/decrease, concentration, speed (rpm), and measuring range (cmg). The Brabender micro visco amylograph is commercially available from C. W. Brabender, South Hackensack, N.J. The test parameters set forth in the general operating procedures (Example 7) and in FIGS. 3-6, are the parameters that were employed to generate the viscosity profiles set forth herein and in the claims.

As used herein the phrase “nail pull” refers to an industry measure of strength, typically measured in pounds, for the amount of force required for the board to be pulled over the head of the nail. A typical nail pull value for gypsum wallboard is in the range of 65 to 85 pounds of force.

By way of introduction, the present invention is directed to a dry-milled starch binder composition for use in a gypsum board slurry, its method of manufacture, and the wallboard product formed therefrom. The starch binder composition of the present invention is formed of a starch component and an acid component. The starch component may be an acid modified dry-milled cereal material or a blend of materials. The acid component may be various acids, such as hydrochloric acid. The binder composition may be formed from an acid modification process having reduced manufacturing costs, and provides one or more improved physical properties to the gypsum board product formed therefrom.

The raw cereal material used in the acid modification process of the present invention may be various whole grains, decorticated grains, and/or fragments or separates thereof, and includes non-glutenous cereal grains and products thereof, such as milo, corn, wheat starches, other grains, and combinations thereof that are processed into a flour material. For example, in certain embodiments of the present invention, the acid modification process employs a milo material, a corn material, or combinations thereof at any blended ratio. The raw cereal grain may be processed into a dry-milled flour material using various processes well known to those of skill in the art. One suitable dry-milled flour process is set forth herein. Alternatively, processed flour is available from various commercial suppliers. For example, dry-milled milo flour may be purchased from Archer Daniels Midland, Dodge City, Kans., and dry-milled corn flour and grits, may be purchased from Archer Daniels Midland, Lincoln, Nebr., for use as a starting material in forming the binder composition of the present invention.

By way of example, one process for generating a dry-milled flour starting material will be discussed herein in the form of cereal products made from milo grain, produced by a dry-milling operation and sifted to fine flour particles. Such flour particles may be referred to as milo flour. The following example is provided by way of illustration only, and is not intended to limit the acid modification process of the present invention or the acid modified starch composition formed therefrom.

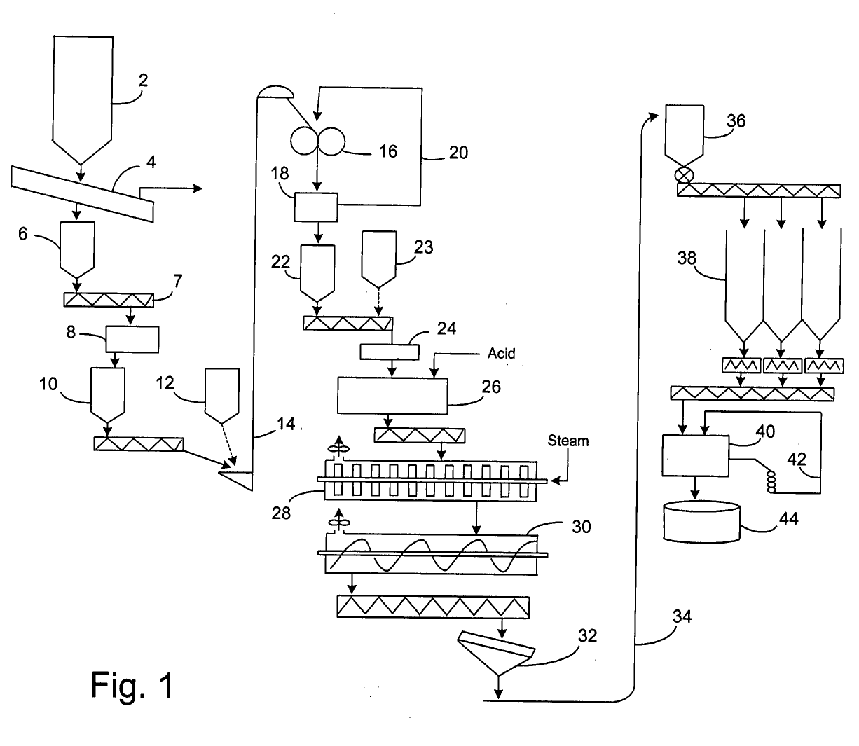

Referring now to FIG. 1, raw cereal grain, such as milo grain, may be transferred from a grain storage facility 2, to begin the process through the dry-milling operation. The grain may be fed through a grain cleaning and separating device 4 for appropriate cleaning and removal of foreign material. The cleaned grain may pass though a surge bin 6 and conveyor 7 that controls the rate of flow of the raw material. The conveyor 7 may be in the form of any type of controlled and calibrated feeder, adjustable so as to deliver the raw material at the desired gravimetric rate. The raw grain material may then be transported by means of a feeding device, such as a temper screw, to debranner 8. Debranner 8 removes the seed coat (pericarp) and through ancillary equipment within that system, the germ is removed in whole or in part, thus reducing the overall fat content of the grit as it is further processed through holding bin 10.

If desired, one or more cleaned, separated, and debranned raw materials of the same or different composition may be supplied by one of more holding bins 12 for blending with the material of holding bin 10 to provide improved properties to the processed flour and/or to provide improved economy to the process. For example, corn grit may be contained in holding bin 12 for blending with the milo material contained in bin 10 at any desired weight ratio. For example, in one embodiment of the present invention, a blend of milo material and corn grit may be conveyed to transport device 14 in weight ratios of, for example, 50:50. Whether or not blended with another stream of material, the milo material from holding bin 10 is transported by means of a feeding device, such as screw auger, to a transport device 14, such as a bucket elevator for further processing.

From transport device 14, the material may be fed to roller mill 16 to provide generally uniform granulation of the raw material into flour. If it is desired to produce a flour product having relatively uniform particle size, the granulated cereal flour may be separated by sifter 18 having a screen size such as 105 to 210 microns, for passing fine flour therethrough to flour bin 22. A recirculation line 20 may be employed for delivering selected coarser particles back through rollers 16 for further processing and sifting. This action may be repeated until the coarse material is of a consistency to pass as fine flour into bin 22 for addition to the acid modification process of the present invention, described below. To provide maximum uniformity or homogeneity of properties of the final product, it is desirable that particles of the raw material be within a relatively limited range of particle size.

It will be apparent to those skilled in the art that the dry-milled starch process set forth above may consist of additional or alternative cleaning, transport, or reduction system components for producing flour product. Also, various size flour particles may be acceptable for processing in the acid modification system. Although the system set forth above describes a flour product that passes through a sifter having a screen as fine as 105 to 210 micron mesh, other fine flour particle sizes may be employed to control the properties of the acid modified dry-milled starch compositions of the present invention. Accordingly, the particle size of the flour fed into mixer 26 is not critical to the process of the present invention except that the economy of over-all operations becomes an important factor. For highly uniform final products, the particles should be relatively evenly processed throughout their mass. Typically, longer processing times are required for larger particles. Thus, it may be more economical to reduce the particle size so as to eliminate excessive size or reduce the number of flour bins.

Flour from bin 22 may be transported by a feeding device, such as a screw auger, into the acid modification system of the present invention. The system may include a batch or continuous mixer 26, a dextrinization unit 28, a cooler 30, and additional sifting and processing equipment set forth below.

Flour entering mixer 26 may be tested for fat content so that the appropriate amount of acid may be added thereto. As provided in more detail below, in certain embodiments of the present invention, fat content of the flour may be one factor used to determine the amount of acid added to the mixer 26 for acid modification. Various fat testing methods known to those of ordinary skill in the art may be employed, such as, for example, Near Infrared Spectrophotometer (NIR), or solvent extraction.

Flour from bin 22 may pass through a measuring device 24 for accurate measurement and/or flow control of the flour for combination with acid in mixer 26. Typically, measuring device 24 is a mechanical or electronic scale. For batch processing, the amount of flour added to the mixer 26 may be selected relative to the size of the mixer, the amount of starch employed, and the anticipated amount of acid added thereto. In one embodiment of the present invention, a batch mixer has a capacity of 5,800 pounds and is suitably sized for processing 5,500 pounds of flour. In embodiments of the present invention where the process is in the form of a continuous feeder of the gravimetric type or of the calibrated volumetric type, the amount of flour added to the mixer 26 may be adjustable so as to deliver the flour at the desired gravimetric rate, such as, for example, 200 pounds to 300 pounds per minute.

If desired, one or more flour streams of the same or different composition may be supplied by one of more additional flour bins 23 for blending with the material of flour bin 22 to provide improved properties to the acid modified composition and/or to provide improved economy to the process. For example, corn flour may be contained in flour bin 23 for blending with the milo flour contained in bin 22 at any desired weigh ratio. In one embodiment of the present invention, a blend of milo flour and corn flour may be conveyed in weight ratios of, for example, 50:50. In this embodiment, flour in bin 23 may also be tested for fat content in a manner similar to the flour tested in bin 22, with this result being factored proportionally into the overall acid determination. Whether or not blended with another stream of material, the milo flour from flour bin 22 may be fed into mixer 26 and agitated for further processing with the acid component.

Mixer 26 may be a batch or a continuous type mixer, and may include, for example, a single or multiple blade mixer, a single or multiple auger, a ribbon-type mixer, a paddle-type mixer, or a cut-flight auger. Mixer 26 may also be self-contained to inhibit the escape of gas and the like therefrom during the application of the acid and reaction with the flour. Accordingly, either batch or continuous processing may be adapted to the process of the present invention employing techniques well know to those of ordinary skill in the art.

The acid may be added to mixer 26 while the flour is agitated to form a dry mixture having an appropriate level of acid content for acid modification. Various organic acids of various concentrations may be employed, such as hydrochloric acid, sulfuric acid, and the like. The amount of acid added to the mixer 26 may depend on various parameters, such as fat content of the milo flour. For example, when a 35 percent concentration of hydrochloric acid is employed, the amount of acid added to the mixer is typically no more than 3.8 cubic centimeters per pound (cc/lb) of flour, usually ranges from 2.4 to 3.6 cc/lb, may range from 2.6 to 3.4 cc/lb, and in some embodiments may range from 3.1 to 3.3 cc/lb. Various methods may be employed to add the acid to the flour, such as, for example, by simple addition or by metered flow. The acid may be added to mixer 26 by techniques known to those of ordinary skill in the art that ensure the slow application of acid to the flour to promote a thorough and complete mixing of the components. Suitable acid addition methods include application by dripping, spraying, atomizing, and pouring. While the acid flow-control system has not been illustrated, such systems are available in several different types, all of equivalent utility, and their use would be apparent to those of ordinary skill in the art.

The present invention may use relatively pure cereal flours having various levels of protein as well as other components, such as ash, fiber, and fat. The properties of the cereal flours may be based upon the many factors that affect the properties of the grain from which it is milled. The cereal grain producer can control some factors through selection of plant varieties and fertilizer application, but there are also environmental factors generally outside the control of the cereal grain producer, such as, the growing and harvest conditions in terms of both temperature and precipitation levels. The ease of starch dextrinization (i.e., how much acid and heat is required) is determined in part by fat content, protein content, amylose:amylopectin ratios, and the like, all of which vary dependent upon the properties of the grain from which it is milled. The presence of the extraneous components in starchy flours imposes the need for particular processing conditions to achieve commercially useful acid-modified flours. It has been determined that the appropriate amount of acid may be adjusted, in part, relative to the fat content of the flour to arrive at improved properties of the binder composition of the present invention.

Control of the acid level relative to the fat content in the starch may be significant for several reasons. It has been determined that predictable and lesser amounts of acid may be added to the mixer 26 of the present invention for acid modification relative to known acid modification systems. Also, a cold water solubility of 5-8 percent was found to be particularly beneficial in obtaining the properties of the binder composition of the present invention. As a result, reduced levels of acid may be employed in the acid modification processes of the present invention, thereby reducing the cost of the raw materials.

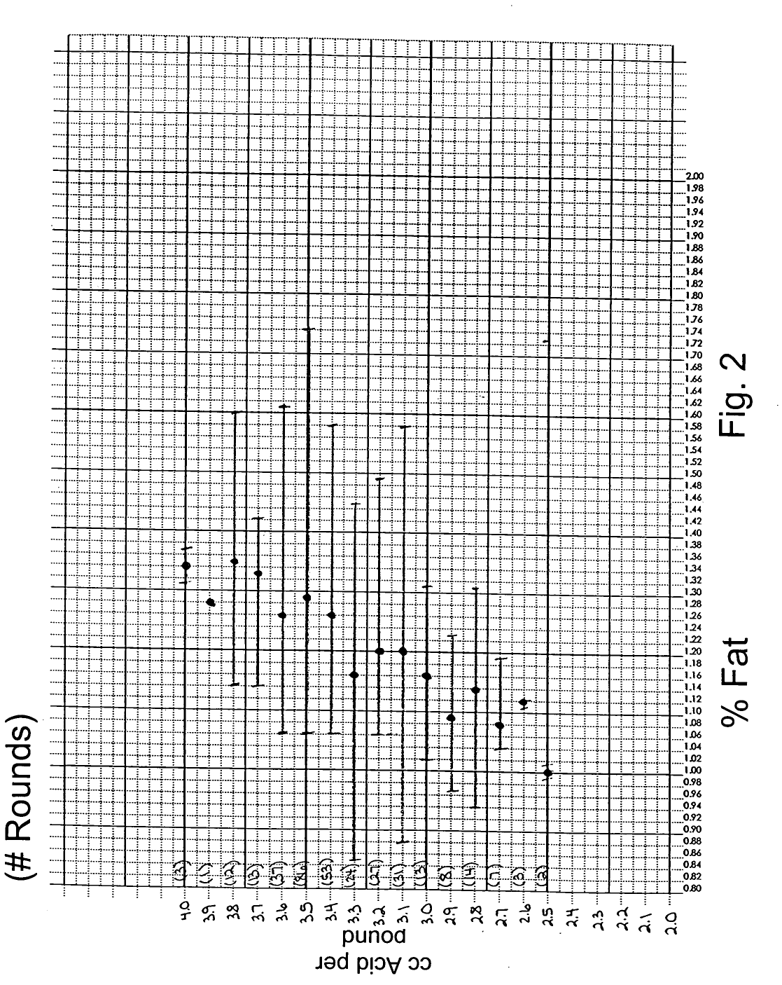

FIG. 2 illustrates that in certain embodiments of the present invention, improved properties in binder compositions may be obtained by selecting appropriate acid levels relative to the average percent fat (represented by each point on the chart) of milo flour and/or a blend of milo/corn flour entering mixer 26. As illustrated, the chart plotting fat percent relative to acid addition per pound of flour shows a generally linear relationship between average fat percent and acid amounts to arrive at the advantages of the present invention. In particular, as the average fat content of each run increased, it was determined that the amount of acid employed in the binder composition should also be increased in order to obtain the particularly unique viscosity profile illustrated and described below. For example, FIG. 2 shows that with average percent fat contents of 1.0, 1.08, 1.16, 1.26 and 1.33, the acid per pound of raw flour was determined to be 2.5, 2.7, 3.0, 3.4, and 3.7 cc/lb, respectively. Although various factors, such as ambient temperature, flour temperature, amylose verse amylopectin ratios, protein matrix configuration, and the like have an effect on this relationship, the acid to fat relationship, nonetheless, is significant during acid modification processing.

Referring again to FIG. 1, following mixing of the appropriate amounts of acid component and flour component in mixer 26, the acidified flour may be transported by means of a feeding device, such as a screw auger, to a dextrinization unit 28 for heating. By means of an inlet pipe, a metered flow of steam may be supplied to unit 28 to raise the temperature of the acidified flour to a controlled level suitable for elevated rates of acid hydrolysis. Reaction temperatures typically range from 72° C. to 85° C., and may be in the range of 76° C. to 79° C. Although the heating time may vary depending on various factors, such as reaction temperature, heating times are typically less than 30 minutes (0.5 hours), typically may range from 15-30 minutes (0.25 to 0.5 hours) for batch processes, and typically may range from 1-15 minutes (0.01 to 0.25 hours) for continuous processes. The mixture may be heated until the desired set temperature and time is reached and the mixture reaches an initial peak viscosity ranging from 1900 to 2600 Brabender Unit (“BU”) torque, with a target viscosity of 2150 BU torque, based on Brabender viscosity analysis. Typically, the time to reach the initial peak is 6.5 to 7.2 minutes.

The acid modified dry milled starch product may then be discharged to a cooler 30 where the acid modified product may be cooled to inhibit progression of the reaction. The product may be held in the cooler 30 until the product reaches an initial peak viscosity ranging from 1200 to 1700 BU torque, with a target viscosity of 1400 BU torque, based on a Brabender viscosity analysis. If the initial peak viscosity of the partially cooled sample is determined to be too high (signifying an undercooked binder material), the batch may be further reacted in product bins 38 prior to packaging by holding the material for an extended period of time therein until the peak viscosity reaches the desired level.

From cooler 30, the material may be conveyed by a feeding device, such as a screw auger, to a screener 32 to remove any oversized (e.g. greater than 0.25 inch) reacted product from the process. The screened product may then be conveyed by a feeding device, such as an airlift 34, to a baghouse filter or cyclone 36 to allow particulates to be separated from the air. Thereafter, the material may be conveyed by a feeding device, such as a screw auger, to one or more product bins 38 for containment. As discussed above, if the initial peak viscosity of the partially cooled sample is determined to be too high, the batch may be held in the product bins 38 for an extended period of time until the peak viscosity reaches the desired level. If desired, one or more product bins 38 may be employed for holding product for complete reaction or for blending various runs of product contained within the product bins 38. In this manner fluxuations, if any, in product properties may be normalized so that a more uniform and homogenized product may be obtained for packaging. For example, in one embodiment of the present invention a series of two or more product bins may be employed, with each bin 38 feeding an amount of product to be blended in a conveying device for final processing.

Whether or not blended with another stream of material, the product material from bin 38 may be conveyed by a feeding device, such as a screw auger, to a sifter 40 wherein coarse materials, if any, are separated to meet desired particle size ranges. Although the sifter 40 may employ any desired size wire mesh screen, in one embodiment of the present invention the sifter 40 employs a 210 to 250 micron screen to pass the acid-modified dry-milled starch product to packaging bin 44. A recirculation line 42 that includes a hammermill may be employed to process selected coarser product and delivering processed product back through sifter 40. This action may be repeated until coarse product material of a desired consistency passes as final product into packaging bin 44 for shipment. To provide maximum uniformity or homogeneity of properties of the final product, it may be desirable that the particles of the final product be within a limited range of particle size.

At the time of packaging a final sample may be taken and its viscosity measured by Brabender viscosity analysis to arrive at a final recorded viscosity profile. It is this final viscosity profile that is illustrated in the figures, the tables, and in the examples set forth below.

The acid modified dry-milled starch binder composition of the present invention has been found to exhibit improved properties over conventional dry-milled binder compositions used in the wallboard industry, at reduced manufacturing cost. As set forth below, certain embodiments of the present invention were measured at significantly lower solids concentrations when compared to conventional binder materials, but were found to exhibit a rapid increase in viscosity upon gelatinization followed by a steep decease in viscosity, without exhibiting an extremely high final viscosity at the end of the final holding period. This viscosity profile may indicate, among other things, that a lesser weight percent of water may be retained in the matrix material when compared to conventional binder compositions, which may result in shorter drying times and lower kiln drying temperatures when formulating drywall products employing the binder composition of the present invention.

Based on test data generated by a Brabender micro visco amylograph, at a starting temperature of 30° C. and a heating/cooling rate of 7.5° C./min, a 14.5% solids concentration of the acid modified dry-milled starch compositions of the present invention displays a unique viscosity profile relative to conventional binder compositions. Compositions of the present invention, at a time 0 through gelatinization, undergo a viscosity increase to a maximum value in the range of 600 and 1600 BU torque at a time in the range of 6.5 to 7.2 minutes, followed by a decrease in viscosity to a value in the range of 240 to 640 BU torque at a time of 8.4 minutes. In certain embodiments of the present invention, the viscosity increases to a maximum value in the range of 750 and 1350 BU torque, and decreases to a value in the range of 300 to 600 BU torque. In certain embodiments of the present invention, the viscosity of the composition may increase to the maximum value at a time in the range of 6.7 to 7.0 minutes. The increase in viscosity to the maximum value may be followed by at least a 40 percent decrease in viscosity, and in some embodiments may be followed by a viscosity decrease in the range of 45 to 65 percent.

Furthermore, based on test data generated by a Brabender micro visco amylograph, at a starting temperature of 30° C., and a heating/cooling rate of 7.5° C./min, a 14.5% solids concentration of the acid modified dry-milled starch composition of the present invention displays a viscosity profile wherein at a time 0 through gelatinization, the composition undergoes a viscosity increase to a maximum value in the range of 600 and 1600 BU torque at a time in the range of 6.5 to 7.2 minutes, followed by a decrease in viscosity and a subsequent increase in viscosity at the end of a final holding period to a value that may be substantially the same as the maximum value. In certain embodiments of the present invention, the increase in viscosity to the maximum value may be in the range of 750 and 1350 BU torque.

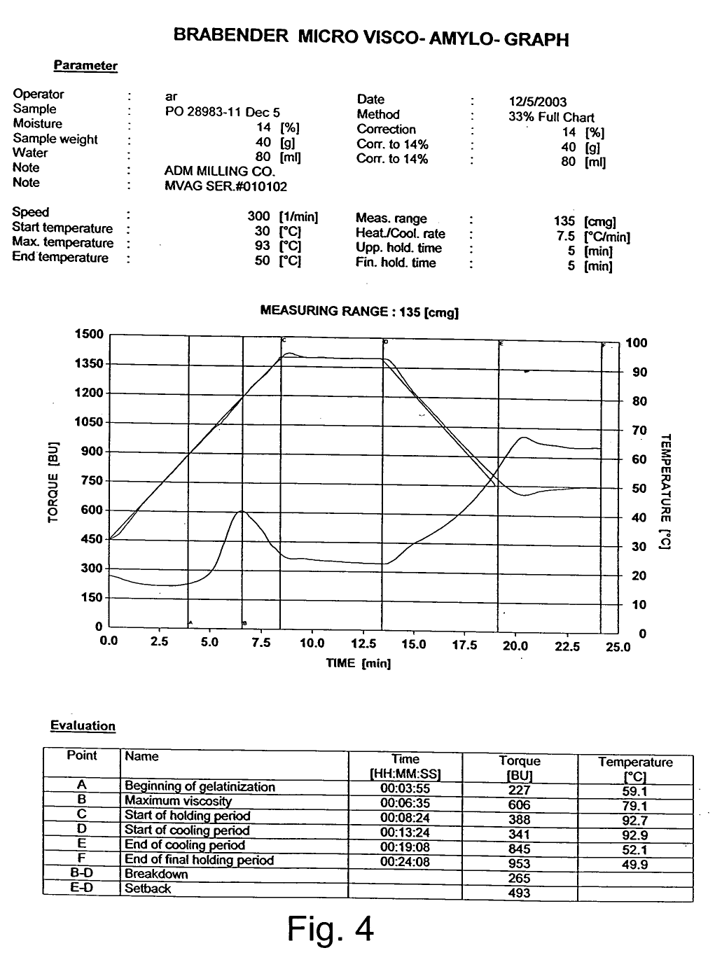

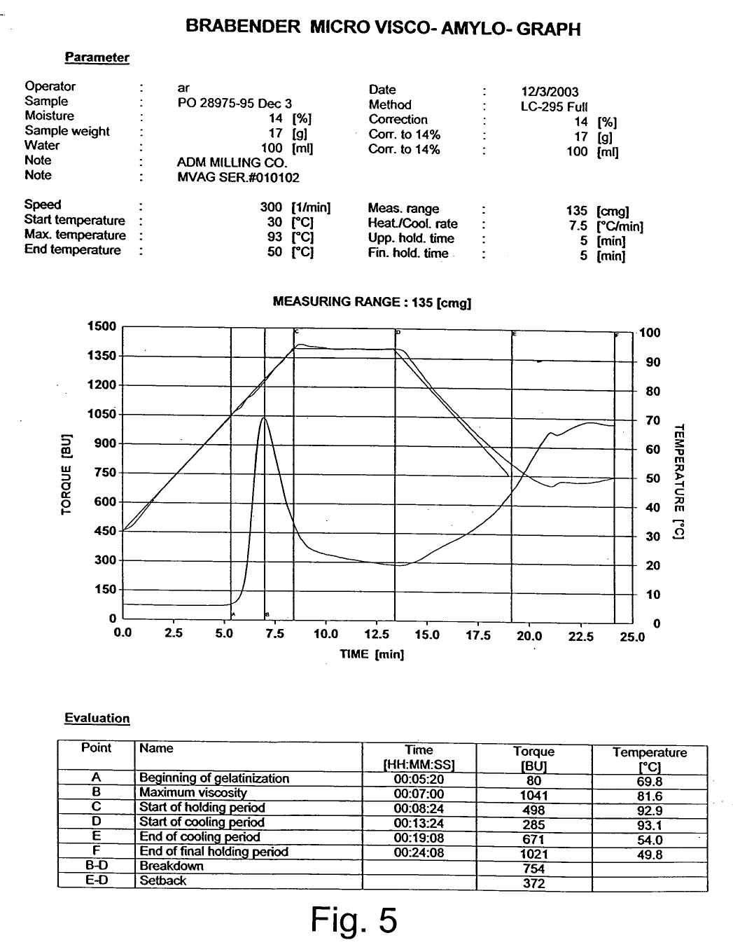

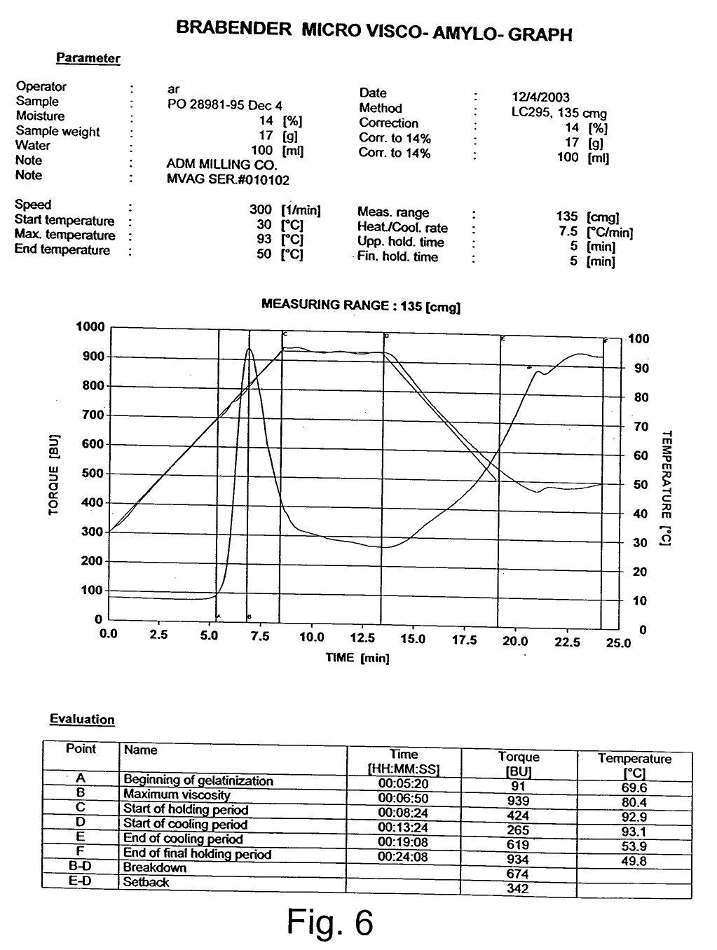

FIGS. 3-6 further illustrate the distinctive viscosity performance characteristics of certain embodiments of the present invention (illustrated in FIGS. 5-6) when analyzed with a Brabender micro visco amylograph relative to conventional binder compositions (illustrated in FIGS. 3-4).

FIGS. 3-4 are micro visco amylographs of a conventional starch binder composition, LC-211, commercially available from Archer Daniels Midland Company, Dodge City, Kans. The LC-211 composition was tested at a 33.3 percent solids. The composition was heated at a starting temperature of 30° C. (time 0) at a constant heating rate of 7.5° C./minute, through the beginning of gelatinization (point A), until the start of the holding period (point C). During the heating cycle, the composition underwent an increase in viscosity to a peak (point B), of 600 to 720 BU torque after a period of approximately 6.5 minutes, followed by a relatively steep drop in viscosity to approximately 380 to 450 BU torque (approximately 40 percent) after 8.4 minutes to the start of the holding period. Through the holding period, the viscosity was relatively constant until the start of the cooling period (point D), at which time the viscosity underwent a dramatic increase to approximately 850 to 1225 BU torque. The viscosity increase continued through the end of the cooling period (point E). As shown in both FIGS. 3 and 4, the viscosity at the end of the final holding period (point F) was significantly higher than the peak viscosity (point B), on the order of 40 percent. This change in viscosity from the initial peak to the final holding period may be problematic in drywall processing because it is known to show a relatively high degree of water retention in the binder matrix material which results in relatively long drying times and higher kiln drying temperatures when formulating drywall products.

In contrast to the results shown in FIGS. 3-4, FIGS. 5-6 illustrate micro visco amylographs of the binder composition of the present invention. The compositions of the present invention were measured at a solids content of 14.5 percent. The decrease in solids percent may be significant for the reasons discussed below. As illustrated, the composition underwent similar heating/holding/cooling processing as the LC-211 composition, set forth above. In particular, compositions of the present invention were heated at a starting temperature of 30° C. (time 0) at a constant heating rate of 7.5° C./minute, through the beginning of gelatinization (point A), until the start of the holding period (point C). During this heating cycle, the composition underwent a steep increase in viscosity to a peak (point B), of approximately 900 to 1050 BU torque after a period of approximately 7 minutes, followed by a relatively steep drop in viscosity to approximately 425 to 500 BU torque (approximately 50 percent) after 8.4 minutes to the start of the holding period. Through the holding period, the viscosity was relatively constant until the start of the cooling period (point D), at which time the viscosity underwent an increase in viscosity to approximately 900 to 1000 BU torque. As shown in both FIGS. 3 and 4, the viscosity at the end of the final holding period (point F) was substantially the same as the peak viscosity (point B).

Table 1, set forth below, illustrates various unique features of the viscosity profiles of a number of formulated acid modified binder compositions of the present invention. As illustrated in Table 1, at the end of the final holding period (point F), the viscosity of the binder composition of the present invention increased to a value that was substantially the same (i.e. ±20 percent) as the initial maximum peak value (point B), typically within ±17 percent, may be within ±11 percent, and in some embodiments may be within ±5 percent of the maximum peak value (as compared to a change in viscosity of approximately 40-50 percent in the LC-211 composition, FIGS. 3-4). Also, the percent drop in viscosity from the initial maximum peak value (point B) to the start of the holding period (point C) may be at least 40 percent, and in some embodiments of the present invention ranges from 45 to 65 percent. Additionally, upon gelatinization of certain embodiments of the binder composition of the present invention, the viscosity increases to a maximum value at a time in the range of 1.0 to 2.0 minutes.

TABLE 1

| | A | A | B | B | C | F | % diff. B | % diff. B |
|---|---|---|---|---|---|---|---|---|
| Run | Time | BU | Time | BU | BU | BU | via C | via F |
| 1 | 5:20 | 91 | 6:50 | 939 | 424 | 934 | −54.85 | −.053 |
| 2 | 5:25 | 92 | 6:50 | 1252 | 570 | 1213 | −54.47 | −3.12 |
| 3 | 5:25 | 125 | 6:55 | 1323 | 616 | 1326 | −53.44 | 0.23 |
| 4 | 5:15 | 88 | 6:50 | 1104 | 464 | | −57.97 | |
| 5 | 5:30 | 91 | 6:55 | 1126 | 513 | 1279 | −54.44 | 13.59 |
| 6 | 5:25 | 85 | 6:55 | 1339 | 661 | 1488 | −50.63 | 11.13 |
| 7 | 5:20 | 81 | 6:50 | 1012 | 439 | 1088 | −56.62 | 7.51 |
| 8 | 5:25 | 86 | 6:50 | 886 | 396 | 955 | −54.22 | 10.40 |
| 9 | 5:25 | 84 | 6:50 | 868 | 380 | 921 | −56.22 | 6.11 |
| 10 | 5:20 | 80 | 6:45 | 772 | Test sequence interrupted | | | |
| 11 | 5:25 | 80 | 6:55 | 991 | 437 | 1120 | −55.90 | 13.02 |
| 12 | 5:20 | 80 | 6:45 | 862 | 374 | 910 | −56.61 | 5.57 |
| 13 | 5:25 | 89 | 6:50 | 889 | 407 | 1008 | −54.22 | 13.39 |
| 14 | 5:25 | 78 | 6:50 | 952 | 425 | 1046 | −55.36 | 9.87 |
| 15 | 5:20 | 76 | 6:50 | 1175 | 519 | 1188 | −55.83 | 1.11 |
| 16 | 5:15 | 76 | 6:45 | 1018 | 438 | 1019 | −56.97 | 0.10 |
| 17 | 5:20 | 70 | 6:50 | 892 | 387 | 883 | −56.61 | −1.01 |
| 18 | 5:25 | 77 | 6:50 | 932 | 402 | 1031 | −56.87 | 10.62 |
| 19 | 5:20 | 81 | 6:50 | 926 | 428 | 1022 | −53.78 | 10.37 |
| 20 | 5:10 | 81 | 6:45 | 1066 | 438 | 1050 | −56.91 | −1.50 |
| 21 | 5:25 | 83 | 6:55 | 953 | 437 | 1021 | −54.14 | 7.14 |
| 22 | 5:25 | 72 | 6:55 | 988 | 432 | 1068 | −56.28 | 8.20 |
| 23 | 5:30 | 84 | 6:55 | 962 | 451 | 1094 | −53.12 | 13.72 |
| 24 | 5:20 | 81 | 6:45 | 1044 | 427 | 1179 | −59.10 | 12.93 |
| 25 | 5:20 | 80 | 6:45 | 1094 | 460 | 1127 | −57.95 | 3.02 |
| 26 | 5:20 | 76 | 6:45 | 934 | 391 | 1001 | −58.14 | 7.17 |
| 27 | 5:20 | 72 | 6:45 | 965 | 388 | 1008 | −59.79 | 4.46 |
| 28 | 5:20 | 85 | 6:45 | 1090 | 445 | 1078 | −59.17 | −1.28 |
| 29 | 5:25 | 72 | 6:50 | 912 | 406 | 955 | −55.48 | 4.71 |
| 30 | 5:20 | 77 | 6:50 | 1090 | 448 | 1099 | −58.90 | 0.83 |
| 31 | 5:25 | 76 | 6:50 | 1240 | 542 | 1264 | −56.29 | 1.94 |
| 32 | 5:20 | 74 | 6:45 | 1211 | 511 | 1246 | −57.80 | 2.89 |
| 33 | 5:15 | 78 | 6:45 | 1247 | 526 | 1170 | −57.62 | −6.17 |
| 34 | 5:20 | 76 | 6:50 | 1281 | 565 | 1179 | −55.89 | −7.96 |
| 35 | 5:10 | 70 | 6:45 | 1272 | 521 | 1124 | −59.04 | −11.64 |
| 36 | 5:15 | 76 | 6:50 | 817 | 362 | 800 | −55.69 | −2.08 |
| 37 | 5:10 | 71 | 6:50 | 1134 | 511 | 1088 | −54.94 | −4.06 |
| 38 | 5:15 | 63 | 6:50 | 926 | 409 | 933 | −55.83 | 0.76 |
| 39 | 5:20 | 77 | 6:50 | 1075 | 467 | 1120 | −56.56 | 4.19 |
| 40 | 5:25 | 80 | 6:55 | 1166 | 613 | 1153 | −56.00 | −1.11 |
| 41 | 5:25 | 86 | 6:55 | 863 | 405 | 885 | −53.07 | 2.55 |
| 42 | 5:25 | 82 | 6:55 | 1027 | 463 | 1074 | −54.92 | 4.58 |
| 43 | 5:25 | 84 | 6:50 | 1169 | 476 | 1138 | −59.26 | −2.65 |
| 44 | 5:25 | 80 | 6:50 | 1087 | 457 | 1087 | −57.96 | 0.00 |
| 45 | 5:25 | 77 | 6:50 | 1054 | 427 | 1059 | −59.49 | 0.47 |
| 46 | 5:20 | 113 | 6:45 | 1144 | 488 | 1107 | −57.34 | −3.23 |
| 47 | 5:20 | 80 | 6:50 | 1037 | Test sequence interrupted | | | |
| 48 | 5:25 | 84 | 6:50 | 1082 | 423 | 1051 | −60.91 | −2.87 |
| 49 | 5:25 | 80 | 6:50 | 1279 | 556 | 1243 | −56.53 | −2.81 |

The invention will be further described by reference to the following examples. The following examples are merely illustrative of the invention and are not intended to be limiting. Unless otherwise indicated, all parts are by weight.

### EXAMPLES

Compositions of the present invention, illustrated in Examples 1-6 herein were manufactured by batch processing. The primary ingredient of the product was a dry-milled raw flour made from milo and/or a blend of milo and corn. The flour was tested to determine fat content, to assist in the determination of the acid rate. The flour was weighed and introduced into a mixer. The appropriate desired set temperature was reached, as set forth below in the Tables. A sample was collected for initial viscosity analysis. When the desired viscosity parameters was obtained (approximately 2150 BU torque), the product was discharged to coolers for cooling to inhibit the progression of the reaction. The cooled product was sampled for viscosity analysis and binned. The product was removed from the product bins and sifted through rebolt sifters, with coarse materials being reground to meet granulation specifications and packaged for shipment. A final viscosity was taken prior to packaging. The measured parameters during processing are as follows:

### Example 1

| Flour | % | Acid | Process Time | Final Cook |
|---|---|---|---|---|
| (lbs) | Fat | (cc/lb) | (min.) | (° C.) |
| 11,600 | 1.00 | 3.4 | 19 | 77 |
| 11,000 | 0.98 | 3.0 | 22 | 76 |
| 11,600 | 1.02 | 3.3 | 18 | 77 |
| 11,000 | 0.99 | 3.0 | 21 | 75 |
| 11,600 | 0.99 | 3.2 | 20 | 77 |

### Example 2

| Flour | % | Acid | Process Time | Final Cook |
|---|---|---|---|---|
| (lbs) | Fat | (cc/lb) | (min.) | (° C.) |
| 11,600 | 1.14 | 2.9 | 20 | 78 |
| 11,000 | 1.00 | 2.6 | 20 | 77 |
| 11,600 | 1.10 | 2.8 | 19 | 78 |
| 11,000 | 1.16 | 2.6 | 19 | 77 |

### Example 3

| Flour | % | Acid | Process Time | Final Cook |
|---|---|---|---|---|
| (lbs) | Fat | (cc/lb) | (min.) | (° C.) |
| 11,000 | 0.97 | 2.9 | 20 | 77 |
| 11,600 | 0.95 | 3.1 | 20 | 78 |
| 11,000 | 1.05 | 2.9 | 20 | 77 |
| 11,600 | 1.03 | 3.1 | 21 | 79 |
| 11,000 | 1.03 | 2.9 | 21 | 78 |

### Example 4

| Flour | % | Acid | Process Time | Final Cook |
|---|---|---|---|---|
| (lbs) | Fat | (cc/lb) | (min.) | (° C.) |
| 11,600 | 1.04 | 2.7 | 19 | 78 |
| 11,000 | 1.11 | 2.5 | 21 | 78 |
| 11,600 | 1.05 | 2.6 | 18 | 77 |
| 11,000 | 1.11 | 2.4 | 20 | 77 |
| 11,000 | 1.01 | 2.6 | 20 | 79 |

### Example 5

| Flour | % | Acid | Process Time | Final Cook |
|---|---|---|---|---|
| (lbs) | Fat | (cc/lb) | (min.) | (° C.) |
| 11,000 | 1.16 | 2.6 | 19 | 77 |
| 11,600 | 1.19 | 2.9 | 20 | 78 |
| 11,000 | 1.21 | 2.6 | 20 | 77 |
| 11,600 | 1.34 | 3.0 | 19 | 77 |

### Example 6

| Flour | % | Acid | Process Time | Final Cook |
|---|---|---|---|---|
| (lbs) | Fat | (cc/lb) | (min.) | (° C.) |
| 11,000 | 1.09 | 2.6 | 26 | 77 |
| 11,600 | 1.04 | 2.8 | 19 | 77 |
| 11,000 | 1.05 | 2.6 | 23 | 77 |
| 11,600 | 1.03 | 2.8 | 19 | 77 |
| 11,000 | 1.01 | 2.7 | 23 | 78 |

Analysis

| | | | | | Start of | End of |
|---|---|---|---|---|---|---|
| | Gelatinazation | | Maximum | | First | First |
| | Onset (A) | | Viscosity (B) | | Hold (C) | Hold (F) |
| Example | Time | BU | Time | BU | BU | BU |
| 1 | 5:25 | 86 | 6:55 | 863 | 405 | 885 |
| 2 | 5:25 | 72 | 6:50 | 912 | 406 | 955 |
| 3 | 5:15 | 76 | 6:45 | 1018 | 438 | 1019 |
| 4 | 5:30 | 91 | 6:55 | 1126 | 513 | 1279 |
| 5 | 5:20 | 74 | 6:45 | 1211 | 511 | 1246 |
| 6 | 5:25 | 125 | 6:55 | 1323 | 616 | 1326 |

As illustrated in Examples 1-6, at a 14.5% solids concentration, compositions of the present invention exhibit a rapid increase in viscosity to an initial peak value of between 850 to 1350 BU torque, followed by a steep drop in viscosity and a subsequent rise in viscosity at the end of the first holding period (F) that is substantially the same as the initial peak.

### Example 7

This example illustrates the general operation procedures of the Brabender micro visco amylograph, employed to generate the viscosity profiles set forth herein. Analysis of the binder compositions set forth herein followed the conventional Brabender micro visco amylograph procedures. For clarity, reference will generally be made to FIGS. 3-6.

The LC-211 samples illustrated in, for example, FIGS. 3-4 were prepared using a sample having 40 grams of binder material and 80 ml of water (i.e. a 33.3 percent slurry concentration). This concentration level was chosen to provide a viscosity profile having an initial viscosity peak that was measurable. The samples of the present invention, illustrated in, for example, FIGS. 5-6, were prepared using a sample having 17 grams of binder material and 100 ml of water (i.e. a 14.5% slurry concentration). This concentration level was chosen to illustrate the viscosity profile of the present invention and the initial viscosity peak at less than half (14.5% versus 33.3% concentration) the starch level. With the exception of the slurry concentration, the same “evaluation pattern” was programmed into the Brabender instrument for both products. The “evaluation patterns” utilized the standard evaluation points (as illustrated in FIGS. 3-6); a method with a speed of 300 rpm, a measuring range of 135 cmg; and a temperature profile using 30° C. as the start temperature, 93° C. as the maximum temperature, and 50° C. as the final temperature. The heating/cooling rate was set at 7.5° C. per minute, with a 5 minute hold at both 93° C. and 50° C.

The samples were prepared and transferred to the sample cup. With the sample cup properly inserted into the instrument, the evaluation pattern described above was initiated. The option of starting the program when the beginning temperature is reached was selected to ensure greater consistency of measurement.

The viscosity profile was generated. As illustrated in FIGS. 3-6, the, generally, top line of the profile is the programmed temperature profile (heated at a constant rate to 95° C., held, cooled at a constant rate to 50° C., and held, all while being stirred at a constant rpm). The line approximating the programmed temperature profile is the actual temperature achieved. The, generally, bottom line is the torque (resistance), the viscosity expressed in Brabender Units.

Analysis of the test data set forth herein show than when the Brabender viscosity profile of compositions of the present invention are compared to the viscosity profile of conventional binder compositions, such as LC-211, the maximum viscosity of compositions of the present invention exhibit the same or higher maximum peak viscosity at less than half the solids concentration (33.3% vs. 14.5%). Accordingly, compositions of the present invention may be formulated with less than half the starch amount as conventional dry-milled binder compositions, but exhibit the same or better viscosity profiles and one or more improved properties. Also, the comparison of the viscosity profiles shows that compositions of the present invention have a more controlled final viscosity (point F), wherein the final viscosity may be substantially the same (i.e. ±20 percent) as the initial peak viscosity, relative to conventional binder compositions, such as LC-211, that have a generally uncontrolled and substantially higher final viscosity compared to their initial peak viscosity.

In addition, the lower amounts of acid and solubility needed to obtain the unique viscosity profile allow reaction times and temperatures to be substantially reduced over conventional binder processes. As set forth above, the processing temperatures of the process of the present invention may be reduced to a temperature of 85° C. or less, typically within the range of 72-85° C., and may be in the range of 76-79° C., while reaction times may be reduced to less than 30 minutes (0.5 hours), typically may range from 15-30 minutes (0.25 to 0.5 hours) for batch processes, and typically may range from 1-15 minutes (0.01 to 0.25 hours) for continuous processes. In contrast, conventional reaction temperatures are typically greater than 100° C., and may be greater than 110° C., while reaction times may be 2 hours or more. Accordingly, the processing costs of the acid modification process of the present invention are significantly less than prior art processes.

The binder composition of the present invention may be incorporated into conventional gypsum wallboard using methods known to those of ordinary skill in the art. Conventional gypsum board fabrication is disclosed in U.S. Pat. Nos. 1,500,452, 2,207,339, 4,009,062, and 5,922,447, which are incorporated by reference herein in their entirety. It has been determined that the binder composition of the present invention, when incorporated into a plaster slurry that forms the gypsum wallboard provides advantages over conventional wallboards that do not employ the binder composition of the present invention. In particular, it has been determined that certain binder compositions of the present invention, when incorporated in a wallboard product, may provide significant industry performance enhancements that may include one or more improved properties. These properties may include: reduced binder usage of 23 percent or more in the plaster slurry that forms the core material; reduced kiln temperatures of 30° F. or more, due, in part, to the rapid hot paste viscosity breakdown that allows water in the gypsum slurry to be released easier; improved humidified bonds, with up to 85 percent reduction in bond failures; greater nail pull resistance; a lighter density wallboard due to greater air entrapment and faster set time; greater flexural strength; and reduced end burn.

It will be appreciated by those skilled in the art that changes could be made to the embodiments described above without departing from the broad inventive concept thereof. It is understood, therefore, that this invention is not limited to the particular embodiments disclosed, but it is intended to cover modifications that are within the spirit and scope of the invention, as defined by the appended claims.

1. An acid modified dry-milled starch composition comprising a viscosity profile wherein at a 14.5% solids concentration, a starting temperature of 30° C., and a heating rate increase of 7.5° C./min, the composition at a time 0 through gelatinization undergoes a viscosity increase to a maximum value in the range of 600 and 1600 BU torque at a time in the range of 6.5 to 7.2 minutes, followed by a decrease in viscosity to a value in the range of 240 to 640 BU torque at a time of 8.4 minutes, based on a Brabender micro visco amylograph.

2. The composition of claim 1, wherein the viscosity increases to a maximum value in the range of 750 and 1350 BU torque.

3. The composition of claim 2, wherein the viscosity decreases to a value in the range of 300 to 600 BU torque.

4. The composition of claim 1, wherein the viscosity increases to the maximum value at a time in the range of 6.7 to 7.0 minutes.

5. The composition of claim 1, wherein the acid modified starch composition is formed from:
an acid component; and
a starch component having an amount of fat, wherein the amount of the acid component is added, at least in part, relative to the fat percent in the starch component.

6. The composition of claim 5, wherein the acid component is hydrochloric acid.

7. The composition of claim 5, wherein the starch component is formed from a starch composition selected from the group consisting of dry milled milo flour, dry milled corn flour, and combinations thereof.

8. A gypsum slurry formed from the starch composition of claim 1.

9. A drywall product formed from a gypsum slurry composition comprising the starch composition of claim 1.

10. An acid modified dry-milled starch composition comprising a viscosity profile wherein at a 14.5% solids concentration, a starting temperature of 30° C., and a heating rate increase of 7.5° C./min, the composition at a time 0 through gelatinization undergoes a viscosity increase to a maximum value in the range of 600 and 1600 BU torque at a time in the range of 6.5 to 7.2 minutes, followed by at least a 40 percent decrease in viscosity at a time of 8.4 minutes, based on a Brabender micro visco-amylo-graph.

11. The composition of claim 10, wherein the viscosity decreases in the range of 45 to 65 percent.

12. The composition of claim 10, wherein the viscosity increases to a maximum value at a time in the range of 6.7 to 7.0 minutes.

13. The composition of claim 10, wherein the acid modified starch composition is formed from:
an acid component; and
a starch component having an amount of fat, wherein the amount of the acid component is added, at least in part, relative to the fat percent in the starch component.

14. The composition of claim 13, wherein the acid component is hydrochloric acid.

15. The composition of claim 13, wherein the starch component is formed from a starch composition selected from the group consisting of dry milled milo flour, dry milled corn flour, and combinations thereof.

16. A gypsum slurry formed from the starch composition of claim 10.

17. A drywall product formed from a gypsum slurry composition comprising the starch composition of claim 10.

18. An acid modified dry-milled starch composition comprising a viscosity profile wherein at a 14.5% solids concentration, a starting temperature of 30° C., and a heating/cooling rate of 7.5° C./min, the composition at a time 0 through gelatinization undergoes a viscosity increase to a maximum value in the range of 600 and 1600 BU torque at a time in the range of 6.5 to 7.2 minutes, followed by a decrease in viscosity and a subsequent increase in viscosity at the end of a final holding period to a value that is substantially the same as the maximum value, based on a Brabender micro visco amylograph.

19. The composition of claim 18, wherein upon gelatinization the viscosity increases to a maximum value in the range of 750 and 1350 BU torque.

20. The composition of claim 18, wherein at the end of the final holding period the viscosity increases to a value that is within 17 percent of the maximum value.

21. The composition of claim 18, wherein at the end of the final holding period the viscosity increases to a value that is within 11 percent of the maximum value.

22. The composition of claim 18, wherein at the end of the final holding period the viscosity increases to a value that is within 5 percent of the maximum value.

23. The composition of claim 20, wherein upon gelatinization the viscosity increases to a maximum value at a time in the range of 1.0 to 2.0 minutes.

24. A gypsum slurry formed from the starch composition of claim 18.

25. A drywall product formed from a gypsum slurry composition comprising the starch composition of claim 18.

26. An acid modified dry-milled starch composition, the composition formed by the process comprising:
combining an acid component and a starch component to form a mixture, wherein the ratio of the acid component is added, at least in part, relative to the fat percent in the starch component;
heating the mixture to a temperature of 85° C. or less for a sufficient time effective to obtain the acid modified starch.

27. The acid modified starch of claim 26, wherein the acid component is hydrochloric acid.

28. The acid modified starch of claim 26, wherein the starch component is formed from a starch composition selected from the group consisting of milo flour, corn flour, and combinations thereof.

29. The acid modified starch of claim 26, wherein the heating is performed at a temperature in the range of 72° C. to 85° C.

30. The acid modified starch of claim 29, wherein the heating is performed at a temperature in the range of 76° C. to 79° C.

31. The acid modified starch of claim 26, wherein the heating is performed for a time of 0.5 hours or less.

32. The acid modified starch of claim 31, wherein the heating is performed for a time in the range of 0.25 to 0.5 hours.

33. The acid modified starch of claim 31, wherein the heating is performed for a time in the range of 0.01 to 0.25 hours.

34. A gypsum slurry formed from the starch composition of claim 26.

35. A drywall product formed from a gypsum slurry composition comprising the starch composition of claim 26.

36. A method of forming an acid modified starch composition, comprising:
combining an acid component and a starch component to form a mixture, wherein the ratio of the acid component is added, at least in part, relative to the fat percent in the starch component;
heating the mixture to a temperature of 85° C. or less for a sufficient time effective to obtain the acid modified starch.

37. The method of claim 36, wherein the heating is performed at a temperature in the range of 72° C. to 85° C.

38. The method of claim 36, wherein the heating is performed at a temperature in the range of 76° C. to 79° C.

39. The method of claim 36, wherein the heating is performed for a time of 0.5 hours or less.

40. The acid modified starch of claim 39, wherein the heating is performed for a time in the range of 0.25 to 0.5 hours.

41. The method of claim 39, wherein the heating is performed for a time in the range of 0.01 to 0.25 hours.

42. The method of claim 36, wherein the acid component is hydrochloric acid.

43. The method of claim 36, wherein the starch component is formed from a starch composition selected from the group consisting of dry milled milo flour, dry milled corn flour, and combinations thereof.

44. The method of claim 36, wherein the amount of acid component is increased, in part, relative to an increase in fat percent in the starch component.

45. The method of claim 44, wherein the amount of acid component increases substantially linearly relative to an increase in the fat percent in the starch component.
